(19) United States
(12) Patent Application Publication
(10) Pub. No.: US 2016/0264152 A1
(43) Pub. Date: Sep. 15, 2016

(54) LOCOMOTIVE ASSEMBLY

(71) Applicant: Electro-Motive Diesel, Inc., LaGrange, IL (US)

(72) Inventors: John David Semple, Woodridge, IL (US); William Thomas Carlson, Monee, IL (US); Chi Khen Truong, Sydney (AU)

(73) Assignee: Electro-Motive Diesel, Inc., LaGrange, IL (US)

(21) Appl. No.: 15/157,819

(22) Filed: May 18, 2016

(51) Int. Cl. B61C 3/02; B60L 9/00; B60L 1/00

(52) U.S. Cl. CPC B61C 3/02; B60L 1/00; B60L 9/00; B60L 2200/26

(57) ABSTRACT

A locomotive assembly is provided. The locomotive assembly includes a locomotive having a power source configured to generate mechanical power. The locomotive also includes a generator configured to generate electrical power. The locomotive further includes an electric motor configured to provide motive power to the locomotive. The locomotive assembly also includes an auxiliary vehicle haying a power receiving device configured to receive electrical power from an external power grid. The auxiliary vehicle also includes a transformer and a circuit breaker. The circuit breaker and the transformer are configured to control the electrical power received by the power receiving device. The auxiliary vehicle further includes a cooling system configured to control a temperature of the transformer. The transformer is further electrically coupled to the electric motor of the locomotive to selectively provide electrical power to the locomotive.

### TECHNICAL FIELD

The present disclosure relates to a locomotive assembly. More particularly, the present disclosure relates to the locomotive assembly for dual mode operation.

### BACKGROUND

Railroads operating in different regions employ different types of locomotives based on an available source of power. For example, railroads having non-electrified systems employ diesel-electric locomotives. Some railroads may have completely electrified systems and may thus employ electric locomotives. However, for railroads that have a mix of non-electrified and electrified systems or where the electrical supply may be unreliable, dual-mode locomotives may be employed.

The dual mode locomotives may operate with electrical power provided by either an onboard engine and a traction alternator or by electrical power provided from an external source such as an overhead wire. Currently, the electrified systems employ the overhead wire having 25000 Volts (V), Single Phase (SP), Alternating Current (AC) electrical supply to power the locomotives. For operation with the 25000V, SP, AC electrical supply, the locomotives may be equipped with a transformer. The transformer may weigh approximately 5 to 8 tonnes depending on power capacity thus adding additional weight to the locomotive.

U.S. Patent Application Number 2015/0367736 describes a device for energy supply for a train set. The device includes one of a hybrid or a diesel electric locomotive. The locomotive includes an electric power generator driven by an engine or a fuel cell which in turn are driven by gas, fuel gas or liquid fuel from a container or a hydrogen storage facility. The electric power generator is connected to a locomotive electrical supply system. The device is arranged to supply the train set with an electric train supply or an idle current of the locomotive provided with or without automatic engine idle stop, and positioned in or on a separate carriage being pulled by the locomotive.

Currently used dual mode locomotives are expensive, complex and heavier than the conventional diesel-electric locomotives due to additional equipment such as the transformer required for electric operation. In many regions, an axle load and space for the additional equipment may be constraints in design of the diesel-electric locomotives. In such regions, the railroads may require the locomotives with relatively light axle loads and with restricted space envelopes. As a. result, the use of the dual-mode locomotives with the additional transformer may be impractical. Hence, there is a need for an improved locomotive for dual mode applications.

### SUMMARY OF THE DISCLOSURE

In an aspect of the present disclosure, a locomotive assembly is provided. The locomotive assembly includes a locomotive. The locomotive includes a power source configured to generate mechanical power. The locomotive also includes a generator mechanically coupled to the power source. The generator is configured to generate electrical power. The locomotive further includes an electric motor electrically coupled to the generator. The electric motor is configured to provide motive power to the locomotive. The locomotive assembly also includes an auxiliary vehicle coupled to the locomotive. The auxiliary vehicle includes a power receiving device configured to receive electrical power from an external power grid. The auxiliary vehicle includes a transformer electrically coupled to the power receiving device. The auxiliary vehicle also includes a circuit breaker electrically coupled to the power receiving device and the transformer. The circuit breaker and the transformer are configured to control the electrical power received by the power receiving device. The auxiliary vehicle further includes a cooling system fluidly coupled to the transformer. The cooling system is configured to control a temperature of the transformer. The transformer is further electrically coupled to the electric motor of the locomotive. The transformer is configured to selectively provide electrical power to the locomotive.

Other features and aspects of this disclosure will be apparent from the following description and the accompanying drawings.

### BRIEF DESCRIPTION OF THE DRAWINGS

FIG. 1 is a perspective view of an exemplary locomotive assembly, according to one embodiment of the present disclosure;

FIG. 2 is a schematic representation of the locomotive assembly of FIG. 1, according to one embodiment of the present disclosure; and

FIG. 3 is a perspective view of an exemplary locomotive assembly, according to another embodiment of the present disclosure.

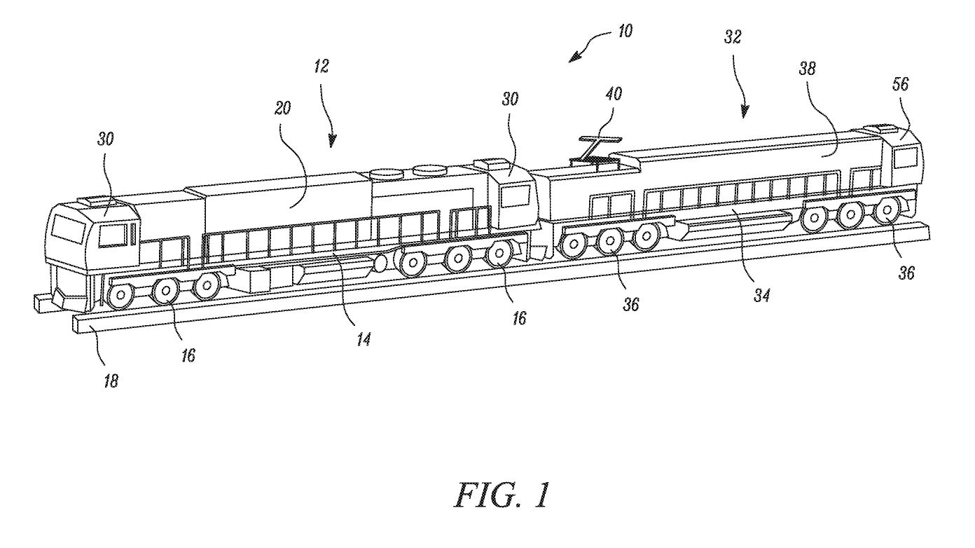

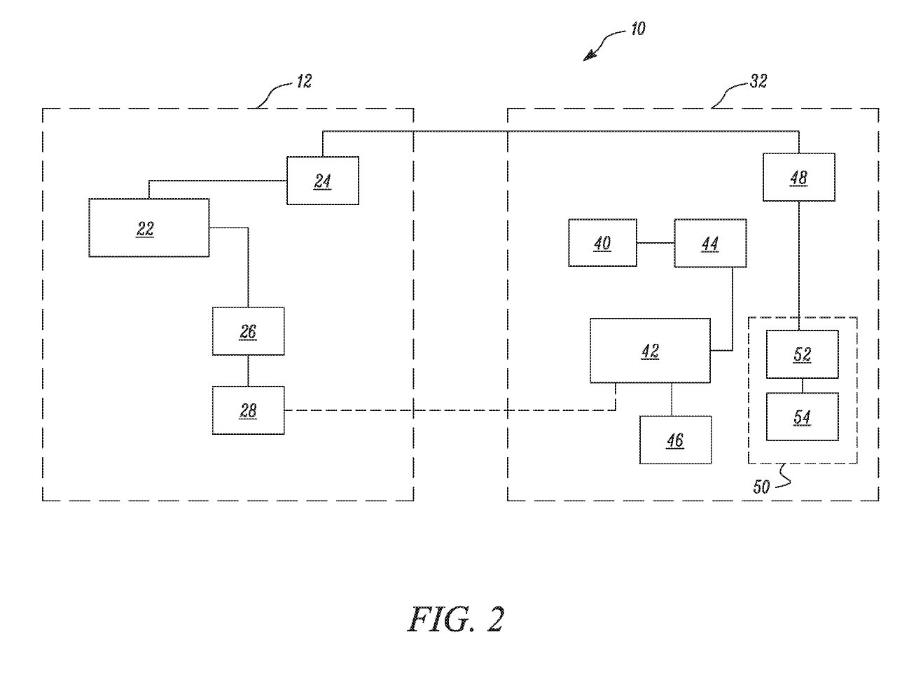

### DETAILED DESCRIPTION

Wherever possible, the same reference numbers will be used throughout the drawings to refer to the same or the like parts. Referring to FIG. 1, an exemplary locomotive assembly 10 is illustrated. The locomotive assembly 10 includes a locomotive 12. The locomotive 12 includes a frame 14. The frame 14 is configured to support one or more components of the locomotive 12, The locomotive 12 includes a set of wheels 16 mounted to the frame 14. The wheels 16 are configured to support and provide mobility to the locomotive 12 on a set of rails 18. The locomotive 12 includes an enclosure 20 mounted on the frame 14. The enclosure 20 is configured to house one or more components (shown in FIG. 2) provided on the frame 14 of the locomotive 12.

Referring to FIG. 2, a schematic representation of the locomotive assembly 10 is illustrated. The locomotive 12 includes a power source 22 provided on the frame 14 and within the enclosure 20. The power source 22 may be any power source known in the art such as an internal combustion engine or a gas turbine. The power source 22 may be powered by any fuel known in the art such as diesel, gasoline, natural gas, and so on, or a combination thereof. The power source 22 is configured to generate mechanical power.

The locomotive 12 includes a fuel tank 24 provided on the frame 14. The fuel tank 24 is fluidly coupled to the power source 22. The fuel tank 24 is configured to store and provide a supply of the fuel to the power source 22. The locomotive 12 includes a generator 26, also known as a traction alternator, provided on the frame 14 and within the enclosure 20. The generator 26 is mechanically coupled to the power source 22. The generator 26 is configured to receive the mechanical power from the power source 22 and generate electrical power.

The locomotive 12 also includes an electric motor 28, also known as a traction motor, provided on the frame 14 and within the enclosure 20. The electric motor 28 is electrically coupled to the generator 26. The electric motor 28 is further coupled to the wheels 16. The electric motor 28 is configured to receive the electrical power from the generator 26 and provide motive power to the wheels 16 of the locomotive 12. Also, the locomotive 12 may include a. transmission system (not shown) coupled between the electric motor 28 and the wheels 16. The transmission system may include various components such as gears, bearings, shafts, axles, and so on. The transmission system is configured to transfer the motive power from the electric motor 28 to the wheels 16.

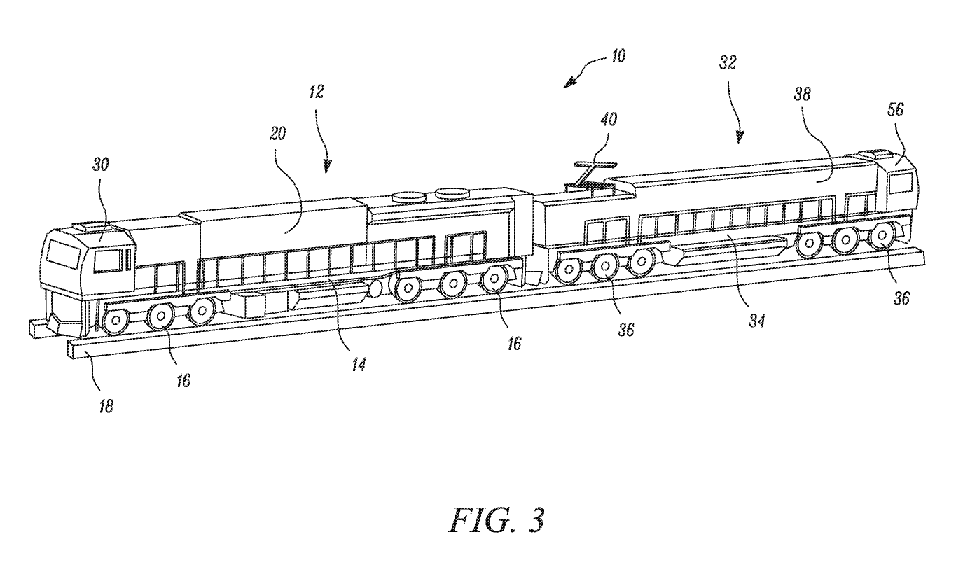

Referring to FIG. 1, the locomotive 12 also includes an operator cabin 30 provided on the frame 14. The operator cabin 30 is configured to house various controls of the locomotive 12 including, but not limited to, levers, pedals, joysticks, buttons, a control interface, audio video devices, a communication system, and an operator seat. The controls are configured to operate and control the locomotive 12. In the illustrated embodiment, the locomotive 12 includes the operator cabin 30 provided on both ends of the locomotive 12. In other embodiments, as shown in FIG. 3, the locomotive 12 may include only one operator cabin 30 provided on one end of the locomotive 12.

Additionally, the locomotive 12 may include various components and/or systems (not shown) provided on the frame 14 and/or within the enclosure 20 such as a fuel delivery system, an air supply system, a cooling system, a lubrication system, an electrical/electronic control system, a rectifier, an inverter, batteries, a safety system, a drive control system, a brake control system, a turbocharger, an exhaust gas recirculation system, an exhaust aftertreatment system, a regenerative braking system, peripheries, and so on based on application requirements without limiting the scope of the disclosure.

Referring to FIG. 1, the locomotive assembly 10 includes an auxiliary vehicle 32 coupled to the locomotive 12. More specifically, the auxiliary vehicle 32 includes a chassis 34 coupled to the frame 14 of the locomotive 12. The chassis 34 is configured to support one or more components of the auxiliary vehicle 32. The auxiliary vehicle 32 includes a set of wheels 36 mounted to the chassis 34. The wheels 36 are configured to support and provide mobility to the auxiliary vehicle 32 on the set of rails 18. The auxiliary vehicle 32 includes an encasement 38 mounted on the chassis 34. The encasement 38 is configured to house one or more components (shown in FIG. 2) provided on the chassis 34 of the auxiliary vehicle 32.

The auxiliary vehicle 32 includes a power receiving device 40 provided on the encasement 38. The power receiving device 40 is configured to receive electrical power from an external power grid. In the illustrated embodiment, the power receiving device 40 is a pantograph. Accordingly, the power receiving device 40 is configured to contact and receive the electrical power from an overhead wire (not shown) of the external power grid. In other embodiments, the power receiving device 40 may be a contact shoe (not shown). Accordingly, the power receiving device 40 may contact and receive the electrical power from a power rail (not shown) of the external power grid.

Referring to FIG. 2, the auxiliary vehicle 32 includes a transformer 42 provided on the chassis 34 and within the encasement 38. The transformer 42 is electrically coupled to the power receiving device 40. The transformer 42 may he any transformer known in the art such as a step down transformer, a step up transformer, and so on based on application requirements. The transformer 42 is configured to control a voltage level of the electrical power received from the power receiving device 40. The transformer 42 is further electrically coupled to the electric motor 28 provided on the locomotive 12. Accordingly, the transformer 42 is configured to selectively provide the electrical power to the locomotive 12 and will be explained in more detail later.

The auxiliary vehicle 32 also includes a circuit breaker 44 provided on the chassis 34 and within the encasement 38. The circuit breaker 44 is electrically coupled to the power receiving device 40 and the transformer 42. The circuit breaker 44 is configured to control an amount of the electrical power flowing from the power receiving device 40 to the transformer 42. The auxiliary vehicle 32 further includes a cooling system 46 fluidly coupled to the transformer 42. The cooling system 46 is configured to control a temperature of the transformer 42.

More specifically, the cooling system 46 may include a cooling jacket (not shown) provided around and/or within the transformer 42. The cooling jacket may include one or more fluid lines routed within and/or around the transformer 42, a fluid envelope around the transformer 42, and so on, or a combination thereof. The cooling jacket is configured to provide a passage for a. flow of a coolant therethrough. Accordingly, the cooling jacket is configured to provide heat transfer between the coolant and the transformer 42.

The cooling system 46 may include a radiator fluidly coupled to the cooling jacket. The radiator may be configured to receive the heated coolant from the cooling jacket and provide heat transfer between the heated coolant and atmosphere. The radiator may then provide the cooled coolant back to the cooling jacket. In addition, the cooling system 46 may include other components such as a coolant tank, a pump, a thermostat, a fan, and so on based on application requirements. In some embodiments, the cooling system 46 may include one or more fans to force air over the transformer 42 in order to control the temperature of the transformer 42.

Additionally, the auxiliary vehicle 32 includes an auxiliary fuel tank 48 provided on the chassis 34 and within the encasement 38. In the illustrated embodiment, the auxiliary fuel tank 48 is fluidly coupled to the fuel tank 24 of the locomotive 12. In other embodiments, the auxiliary fuel tank 48 may be fluidly coupled to the power source 22. The auxiliary fuel tank 48 is configured to store and provide a supply of the fuel to the power source 22. In the illustrated embodiment, the auxiliary fuel tank 48 provides as a secondary storage for the fuel in addition to the fuel tank 24 provided on the locomotive 12. In other embodiments, when the fuel tank 24 of the locomotive 12 may be omitted due to space, weight and/or other constraints, the auxiliary fuel tank 48 may provide as a primary storage for the fuel.

The auxiliary vehicle 32 also includes an auxiliary generator set 50 provided on the chassis 34 and within the encasement 38. The auxiliary generator set 50 may include an auxiliary power source 52. The auxiliary power source 52 may he any power source known in the art such as an internal combustion engine or a gas turbine. The auxiliary power source 52 is configured to generate mechanical power. The auxiliary power source 52 may be powered by any fuel known in the art such as diesel, gasoline, natural gas, and so on, or a combination thereof.

In the illustrated embodiment, the auxiliary power source 52 is fluidly coupled to the auxiliary fuel tank 48. Accordingly, the auxiliary power source 52 is configured to receive the fuel from the auxiliary fuel tank 48. In other embodiments, the auxiliary power source 52 may be fluidly coupled to the fuel tank 24 of the locomotive 12. Accordingly, the auxiliary power source 52 may be configured to receive the fuel from the fuel tank 24 of the locomotive 12. In yet other embodiments, the auxiliary power source 52 may be fluidly coupled to a separate fuel tank (not shown) provided on the auxiliary vehicle 32 or the locomotive 12 and different from the auxiliary fuel tank 48 and the fuel tank 24.

The auxiliary generator set 50 also includes an auxiliary generator 54 provided on the chassis 34 and within the encasement 38. The auxiliary generator 54 is mechanically coupled to the auxiliary power source 52. The auxiliary generator 54 is configured to receive the mechanical power from the power source 22 and generate auxiliary electrical power. The auxiliary generator set 50 is configured to provide the auxiliary electrical power to the locomotive 12 and/or a number of wagons (not shown) coupled to the locomotive assembly 10. The auxiliary electrical power may be provided for applications such as lighting, heating, ventilation, air conditioning, refrigeration, and so on for the locomotive 12 and/or the wagons coupled to the locomotive assembly 10.

Referring to FIG. 3, the auxiliary vehicle 32 also includes an operator cabin 56 provided on the chassis 34. The operator cabin 56 is configured to house various controls of the auxiliary vehicle 32 including, but not limited to, levers, pedals, joysticks, buttons, a control interface, audio video devices, a communication system, and an operator seat. The controls are configured to operate and control the auxiliary vehicle 32. In the illustrated embodiment, the auxiliary vehicle 32 includes the operator cabin 56 provided on one end of the auxiliary vehicle 32. In other embodiments (not shown), the auxiliary vehicle 32 may include the operator cabin 56 provided on both ends of the auxiliary vehicle 32.

Additionally, the auxiliary vehicle 32 may include various components and/or systems provided on the chassis 34 and/or within the encasement 38 such as a fuel delivery system, an electrical/electronic control system, a rectifier, an inverter, batteries, a safety system, a brake control system, a regenerative braking system, peripheries, and so on based on application requirements without limiting the scope of the disclosure.

### INDUSTRIAL APPLICABILITY

The present disclosure relates to the locomotive assembly 10 configured for dual mode operation. During operation of the locomotive assembly 10 on non-electrified railroad systems, the locomotive assembly 10 may be operated on a semi-electric mode. The semi-electric mode may be a diesel-electric mode, a gas-electric mode, or any other type of fuel-electric mode based on type of the locomotive 12 and/or application requirements. In the semi-electric mode, the power source 22, the generator 26, and the electric motor 28 of the locomotive 12 are operational and are used to generate the motive power for the locomotive assembly 10 and/or the wagons coupled to the locomotive assembly 10. Also, during the semi-electric mode, the power receiving device 40 and thus the circuit breaker 44 and the transformer 42 are non-operational.

During operation of the locomotive assembly 10 on electrified railroad systems, the locomotive assembly 10 may be optionally operated on an electric mode. in the electric mode, the power receiving device 40, the circuit breaker 44, and the transformer 42 on the auxiliary vehicle 32 are operational and are used to selectively provide electrical power from the external power grid to the electric motor 28 of the locomotive 12. The electric motor 28 in turn provides the motive power to the locomotive assembly 10 and/or the wagons coupled to the locomotive assembly 10. Also, in the electric mode, the power source 22 and the generator 26 of the locomotive 12 are non-operational. The locomotive assembly 10 may be switched between the electric mode and the semi-electric mode based on operator commands received from the operator cabin 30 of the locomotive 12 or the operator cabin 56 of the auxiliary vehicle 32.

The auxiliary fuel tank 48 provided on the auxiliary vehicle 32 provides as the secondary storage for the fuel. Due to lower space and/or weight constraints on the auxiliary vehicle 32, a size of the auxiliary fuel tank 48 may be considerably larger than a size of the fuel tank 24 on the locomotive 12. As such, the auxiliary fuel tank 48 may provide to increase an operating range of the locomotive assembly 10 on the semi-electric mode and provide inline fueling of the locomotive 12. Also, in situations, when the auxiliary fuel tank 48 may serve as the primary storage for the fuel, the auxiliary fuel tank 48 may provide to reduce the space and/or weight constraints on the locomotive 12.

The auxiliary generator set 50 provided on the auxiliary vehicle 32 provides the auxiliary electrical power for the locomotive assembly 10 and/or the wagons coupled to the locomotive assembly 10. As such, the auxiliary generator set 50 may enable omission of a separate generator wagon for the auxiliary electrical power. Further, the operator cabin 56 provided on the auxiliary vehicle 32 may provide added functionality and/or improved visibility to the locomotive assembly 10.

The locomotive assembly 10 provides a simple, efficient and cost effective locomotive 12 for dual mode operation. The auxiliary vehicle 32 provides distribution of components used for the electric mode operation of the locomotive 12. As a result, the auxiliary vehicle 32 provides reduction of an axle load and/or space constraint on the locomotive 12. Also, due to lower space and/or weight constraint of the auxiliary vehicle 32, the auxiliary fuel tank 48, the auxiliary generator set 50, the operator cabin 56, and/or other components of the locomotive 12 may be added on the auxiliary vehicle 32 to provide improved space and/or weight distribution, and improved functionality thereof. Also, the auxiliary vehicle 32 may be coupled to any conventional semi-electric locomotive such as a diesel-electric locomotive or a gas-electric locomotive with minor or no modifications in order to add the dual mode capability to the conventional semi-electric locomotive.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. A locomotive assembly comprising:
a locomotive including:
a power source configured to generate mechanical power;
a generator mechanically coupled to the power source, the generator configured to generate electrical power: and
an electric motor electrically coupled to the generator, the electric motor configured to provide motive power to the locomotive; and
an auxiliary vehicle coupled to the locomotive, the auxiliary vehicle including:
a power receiving device configured to receive electrical power from an external power grid;
a transformer electrically coupled to the power receiving device and the electric motor of the locomotive, the transformer configured to selectively provide electrical power to the locomotive;
a circuit breaker electrically coupled to the power receiving device and the transformer, the circuit breaker and the transformer configured to control the electrical power received by the power receiving device; and
a cooling system fluidly coupled to the transformer, the cooling system configured to control a temperature of the transformer.

2. The locomotive assembly of claim 1 further including an auxiliary fuel tank provided on the auxiliary vehicle and fluidly coupled to the power source, the auxiliary fuel tank configured to provide a supply of fuel to the power source.

3. The locomotive assembly of claim 1 further including an auxiliary generator set provided on the auxiliary vehicle, the auxiliary generator set configured to provide an auxiliary electrical power to at least one of the locomotive and a plurality of wagons coupled to the locomotive assembly.
